(19) United States
(12) Patent Application Publication
(10) Pub. No.: US 2010/0299984 A1
(43) Pub. Date: Dec. 2, 2010

(54) SIGNAGE INCLUDING INTERLOCKING MECHANICAL FASTENERS

(75) Inventors: Sithya S. Khieu, Eden Prairie, MN (US); David C. May, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/472,545

(22) Filed: May 27, 2009

(51) Int. Cl. G09F 15/00; G09F 7/00

(52) U.S. Cl. 40/612; 40/607.13

(57) ABSTRACT

The present application relates to a sign including: (1) a sign blank including multiple first interlockable members; and (2) optically active sheeting including multiple second interlockable members; wherein the first and second matable members interlock with one another to hold the sign blank and the sheeting together.

### TECHNICAL FIELD

The present application relates generally to reflective and retroreflective signs, and more particularly, to signs including interlocking mechanical fasteners.

### BACKGROUND

The term “sign” as used herein refers to a stand-alone article that conveys information, usually by means of alphanumeric characters, symbols, graphics, or other indicia, and that in use is mounted to an object such as a post, bracket, wall, or similar body. Specific examples include signs used for traffic control purposes (STOP, YIELD, speed limit, informational, roadside markers, etc.), street signs, and vehicle license plates. The term “retroreflective” as used herein refers to the attribute of reflecting an obliquely incident light ray in a direction antiparallel to its incident direction, or nearly so, such that it returns to the light source or the immediate vicinity thereof.

Two known types of retroreflective sheeting are microsphere-based sheeting and cube corner sheeting. Microsphere-based sheeting, sometimes called “beaded” sheeting, employs a multitude of microspheres typically at least partially imbedded in a binder layer and having associated specular or diffuse reflecting materials (e.g., pigment particles, metal flakes, vapor coats) to retroreflect incident light. In contrast, cube corner retroreflective sheeting comprises a body portion typically having a substantially planar front surface and a rear structured surface comprising a plurality of cube corner elements. Each cube corner element comprises three approximately mutually perpendicular optical faces that cooperate to retroreflect incident light.

Typically, a sign 10 (shown schematically in FIG. 1) that includes retroreflective sheeting is manufactured as follows. As is shown schematically in FIG. 2, sign blank 12 is provided which is typically, for example, a rigid mass of metal, wood, plastic, composite, or the like. “Sign blank” as used herein means a rigid substrate suitable for mounting in the intended end use application. Retroreflective sheeting 20 is prepared by, for example, removing a release liner 34 so as to expose a pressure sensitive adhesive (PSA) layer 30. Then sheeting 20 is applied to a generally smooth, flat major (front) surface 14 of sign blank 12 so that the pressure sensitive adhesive layer 30 contacts the major (front) surface 14 of sign blank 12. Letters, symbols, or other indicia may be added either before or after sheeting 20 is applied to sign blank 12. Some signs, such as certain road shoulder markers, carry no indicia at all but are merely affixed to a post at the side of the road.

In an alternative manufacturing process, retroreflective sheeting is attached to a sign blank by screws, rivets, or nails that are drilled or driven through one or more of the retroreflective sheeting and the sign blank.

### SUMMARY

The present application relates to a sign including: (1) a sign blank having opposed first and second major surfaces and a first fastener component on the first major surface of the sign blank; and (2) a sheeting having opposed first and second major surfaces and a second fastener component on the first major surface of the sheeting; wherein the first and second fastener components are capable of matably engaging one another and of holding the sign blank and the sheeting together.

The present application also relates to a sign including: (1) a sign blank including multiple first interlockable members; and (2) sheeting including multiple second interlockable members; wherein the first and second matable members interlock with one another to hold the sign blank and the sheeting together.

The present application also relates to a sign blank including: a piece of rigid material; and a first matable fastener attached to the piece of rigid material. The sign blank may further include a sign sheeting attached to a second matable fastener wherein the second matable fastener is capable of matably attaching to the first matable fastener.

The present application also relates to a sign sheeting including optically active (e.g., retroreflective or reflective) sheeting; and a second matable fastener attached to the optically active sheeting. The sign sheeting may further include a piece of rigid material having a first matable fastener attached to the piece of rigid material wherein the second matable fastener is capable of matably attaching to the first matable fastener.

### BRIEF DESCRIPTION OF DRAWINGS

FIG. 1 is a schematic view of a prior art sign.

FIG. 2 is a schematic cross-sectional view of the sign of FIG. 1.

FIG. 3 is a schematic cross-sectional view of one exemplary sign blank and sheeting of the present application.

FIG. 4 is a schematic cross-sectional view of another exemplary sign blank and sheeting of the present application.

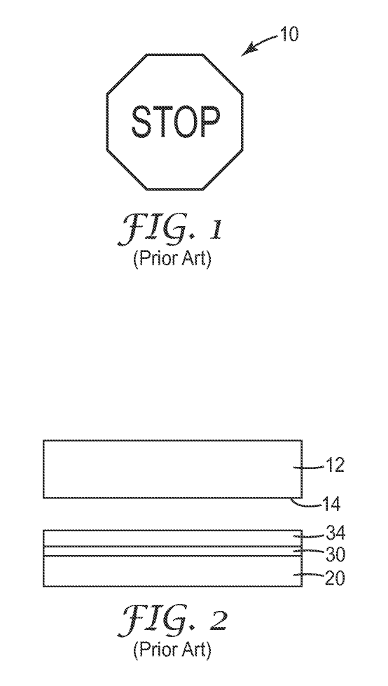

### DETAILED DESCRIPTION

Conventional traffic signs have some disadvantages. For example, the PSAs or other adhesives used to attach the optically active (e.g., reflective or retroreflective) sheeting to the sign blank can (1) exhibit shock failure in cold temperatures; (2) exhibit sheer or creep in hot temperatures; (3) wrinkle in humid climates; (4) exhibit liner curling or instability during fabrication; and (5) ooze into undesired locations causing edge tackiness, all of which can result in poor sign performance. Further, PSAs and other adhesives can have limited positionability because of their inherent tackiness. As a result, a minor error in placement of the sheeting onto the sign blank can destroy the entire sign, resulting in increased manufacturing cost. Manufacturing cost is also relatively high because of the cost of the release liner, which is waste, as it is not used in the final sign.

The inventors of the present application recognized these disadvantages and also recognized a continuing need to improve the performance, reduce the cost, and/or to simplify the manufacture of retroreflective signs. The inventors recognized that the typical sign blank-sheeting attachment system and method has various disadvantages that can be minimized or eliminated by an improved sign blank-sheeting attachment system and method.

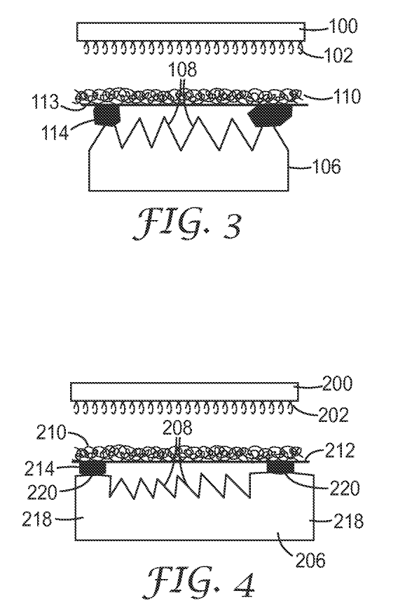

One improved sign blank-sheeting attachment system is shown schematically in FIG. 3. FIG. 3 includes a sign blank 100 including multiple first interlockable members or fastener components 102 and prismatic retroreflective sheeting 106 including multiple geometric structures 108 (shown as prisms in FIG. 3).

The specific type of first interlockable members 102 shown in FIG. 3 have a woven or film backing with flexible self-supporting J-shaped hooks protruding up from a woven backing. The term mechanical fastener or interlockable member refers to a mechanical fastener comprising a fastening component having one or two matable or interlocking surface components by which two such fastening components can become releasably attached at some point during construction. First interlockable member 102 can either be made integral to sign blank 100 or adhesively bonded to it.

The specific type of second interlockable members or fastener components 110 of FIG. 3 have a woven or film backing covered with soft, pliable loops, providing for opening and closing cycles. In the embodiment shown in FIG. 3, second interlockable member 110 is welded to or otherwise sealed with at least some of geometric structures 108 of prismatic retroreflective sheeting 106, forming a weld or seal line 114. Second interlockable member 110 is preferably positioned to create a space between the tops of geometric structures 108 and second interlockable member 110, which facilitates the total internal reflection of light off of geometric structures 108. When sign blank 100 and prismatic retroreflective sheeting 106 are matably coupled (e.g., pushed or slid together), first and second interlockable members 102 and 110 interlock with one another to hold sign blank 100 and prismatic retroreflective sheeting 106 together, thereby forming a sign. Fastener components 102 and 110 can be interchangeably attached to sign blank 100 or sheeting 106.

Another improved sign blank-sheeting attachment system is shown schematically in FIG. 4. FIG. 4 includes a sign blank 200 including multiple first interlockable members 202. In the embodiment shown in FIG. 4, first interlockable members 202 have a woven or film backing with flexible self supporting J shaped hooks protruding up from a woven backing that can be adhesively bonded or heat sealed to the sign blank 200. The embodiment of FIG. 4 also includes prismatic retroreflective sheeting 206 including multiple geometric structures 208 (shown as prisms in FIG. 4). Multiple second interlockable members 210 are attached to a fastener component 212 that is welded to or otherwise sealed with an energy director 218, forming a weld or seal line 214. Energy directors 218 are raised ridge partitions that are slightly higher than the height of the geometric structures 208. The energy directors also provide a mechanism for protecting adjacent geometric structures 208 from damage during the sealing process. The exemplary energy director 218 shown in FIG. 4 has raised ridges 220 to which fastener component 212 is welded, sealed, or otherwise attached. Sealing can be effected by, for example, heat sealing using mechanical vibration or ultrasonic welding.

Fastener component 212 is preferably positioned to create a space between the tops of geometric structures 208 and fastener component 212, which facilitates the total internal reflection of light off of geometric structures 208. When sign blank 200 and prismatic retroreflective sheeting 206 are matably coupled, first and second interlocklable members interlock with one another to hold sign blank 200 and prismatic retroreflective sheeting 206 together, thereby forming a sign.

The above-described embodiments are examples of the signs, attachment systems, and methods of the present application. Many modifications to these examples can be made while still falling within the inventive concept of the present application. For example, the sheeting attached to the sign blank can be, for example, retroreflective sheeting (e.g., prismatic or beaded), reflective sheeting, or any other type of optically active sheeting. Those of skill in the art will appreciate that when non-prismatic sheeting is used, a space for total internal reflection may not be necessary. Also, the sign blank can be any rigid substrate suitable for mounting in the intended end use application including, for example, a rigid mass of metal, wood, plastic, a composite substrate, or the like.

The first and second interlockable members can be any members capable of interlocking or mating that do not require puncturing of either the sign blank or the sheeting including, for example, hook and loop fasteners (e.g., Scotchmate™ brand fasteners sold by 3M Company of St. Paul, Minn. and VELCRO™ brand fasteners sold by Velcro Industries N.V. of the Netherlands). Additionally, any method or means of attaching the interlocking or mating fasteners to each of the sign blank and the sheeting can be used including, for example, incorporating the interlockable fasteners into the sign blank or sheeting construction using 3M™ Dual Lock™ Reclosable Fasteners, use of heat lamination, or use of adhesives, including, for example, PSAs. Further, the interlockable fasteners on either the sign blank or the sheeting can cover the entire sign blank or sheeting surface or can cover only a part of the sign blank or sheeting surface. In one exemplary implementation, the first fastener component is on at least 50% of the first major surface of the sign blank and the second fastener component is on at least 50% of the first major surface of the sheeting. The interlocking members can be placed on the sign blank or sheeting surface in an array, in a design, randomly, only on the outer edges, in a matrix, etc. In at least one preferred implementation, the number of interlockable members on at least one of the sign blank or the sheeting are at least 5 interlockable members per inch of sheeting or sign blank. The nature of the interlockable fasteners can be such that the attachment of the sign blank to the sheeting is either permanent or temporary.

In at least one preferred implementation, the edges of sign 100 or 200 are edge or perimeter sealed to prevent water, dew, etc. from accessing the internal portion of the sign and to reduce the risk of tampering with the sign by removal of the sheeting. This sealing can be accomplished by, for example, applying tape around the perimeter of the sign, using thermal stitching, or applying a putty filling compound such as, for example, Scotch-Weld™ Structural Void Filling Compound 3550 B/A FST, 3M™ Lightweight Body Filler, or 3M™ Premium Body Filler Gold QBA. Alternatively or additionally, where the interlockable fasteners are formed of thermoplastic materials, the attached sign blank and sheeting can be exposed to at least one of temperature and pressure to melt the interlockable elements together, thereby furthering the bond strength between the sign blank and sheeting and effectively sealing the perimeter of the sign.

Some potential advantages of the attachment method and system of the present application include (1) less expensive manufacturing; (2) more environmentally friendly manufacturing due to the elimination of the PSA layer, which requires the use of potentially harmful solvents; (3) increased shock sensitivity of the resulting sign; and (4) more ergonomic and easier installation.

The following examples describe some exemplary constructions of various embodiments of the signage articles and attachment systems described in the present application.

### EXAMPLE 1

A sign (8 inches by 6 inches (20.3 cm by 15.2 cm)) consisting of retroreflective sheeting adhered to a substrate by means of fastener components was prepared. The substrate was an 0.080 in. (0.2 cm) thick aluminum sheet available from Vulcan, Ala., USA. The retroreflective sheeting was “Diamond Grade DG3 Reflective Sheeting Series 4000” available from 3M Company, St. Paul, Minn., USA. Two types of fastener components were used: “Scotchmate Reclosable Fastener Hook SJ3572” (first fastener component) and “Scotchmate Reclosable Fastener Loop SJ3572” (second fastener component), both available from 3M Company. The fastener components were of the type hook and loop and included an adhesive layer protected by a release liner.

The fastener components were cut into 8 in. by 6 in. (20.3 cm by 15.2 cm) rectangles. Upon removal of the release liner, the first fastener component was adhered to a major surface of the substrate and manually pressed against the substrate to promote adhesion. In a similar fashion, the second fastener component was adhered to the non-optically active (back side) of the retroreflective sheeting and manually pressed against it to promote adhesion.

The substrate was placed on a flat surface with the first fastener component facing upward. The retroreflective sheeting, with the second fastener component facing downward, was visually aligned with the substrate and manually pressed against it to interlock the first and second fastener components.

### EXAMPLE 2

A sign was prepared as described in Example 1, except the substrate was a fiber reinforced polypropylene honeycomb core sandwich composite, available from Plascore, Mich., USA, under the trade designation “PPSLICE05.”

After interlocking the first and second fastener components, the edge of the honeycomb substrate was filled with a curable adhesive, available from 3M Company under the trade designation “Scotch-Weld Structural Void Filling Compound 3550 B/A FST,” using a pneumatic gun available from 3M Company. The adhesive was allowed to cure at room temperature for 48 hours to seal the edges of the sign, therefore preventing water, dirt, etc. from accessing the internal portion of the sign.

### EXAMPLE 3

A sign was prepared as described in Example 2, except that the fastener components were stems with mushroom shaped tops, available from 3M Company under the trade designation “Dual Lock Reclosable Fasteners SJ3756 Type 170.”

Various modifications and alterations of the present disclosure will become apparent to those skilled in the art without departing from the spirit and scope of the disclosure. The scope of the present disclosure should, therefore, be determined only by the following claims.

What is claimed is:

1. A sign, comprising:
a sign blank having opposed first and second major surfaces and a first fastener component on the first major surface of the sign blank; and
a sheeting having opposed first and second major surfaces and a second fastener component on the first major surface of the sheeting;
wherein the first and second fastener components are capable of matably engaging one another and of holding the sign blank and the sheeting together.

2. The sign of claim 1, in which the first fastener component is on at least 50% of the first major surface of the sign blank and the second fastener component is on at least 50% of the first major surface of the sheeting.

3. The sign of claim 1, in which neither of the first and second fastener components puncture the sign blank or the sheeting.

4. The sign of claim 1, in which the sign blank includes at least five first fastener components per square inch.

5. The sign of claim 1, in which the sheeting includes at least five second fastener components per square inch.

6. The sign of claim 1, in which the sign blank includes a composite and the first fastener is built integrally into the composite.

7. The sign of claim 1, in which the sheeting is one of retroreflective or reflective sheeting.

8. The sign of claim 1, in which the sign is one of a type used for traffic control purposes, a street sign, or a license plate.

9. The sign of claim 1, in which sign blank is formed of metal, wood, composite, or plastic.

10. A sign, comprising:
a sign blank including multiple first interlockable members; and
sheeting including multiple second interlockable members;
wherein the first and second interlockable members interlock with one another to hold the sign blank and the sheeting together.

11. The sign of claim 10, in which one or both of the first and second interlockable members is distributed on the sign blank or sheeting in an ordered array or pattern.

12. The sign of claim 10, in which one or both of the first and second interlockable members is distributed on the sign blank or sheeting at random.

13. The sign of claim 10, in which at least 50% of the sign blank includes the first interlockable member and at least 50% of the sheeting includes the second interlockable member.

14. The sign of claim 10, in which neither of the first and second interlockable members puncture the sign blank or the sheeting.

15. The sign of claim 10, in which the sign blank includes at least five first interlockable members per square inch.

16. The sign of claim 10, in which the sheeting includes at least five second interlockable members per square inch.

17. The sign of claim 10, in which the sign blank includes a composite and the first interlockable member is built integrally into the composite.

18. A sign blank, comprising:
a piece of rigid material; and
a first matable fastener attached to the piece of rigid material.

19. The sign blank of claim 18, further comprising:
a sign sheeting attached to a second matable fastener, the second matable fastener capable of matably attaching to the first matable fastener.

20. A sign sheeting, comprising:
optically active sheeting; and
a second matable fastener attached to the optically active sheeting.

21. The sign sheeting of claim 20, further comprising:
a piece of rigid material to which is attached a first matable fastener; wherein the second matable fastener is capable of matably attaching to the first matable fastener.
